(19) United States
(12) Patent Application Publication
(10) Pub. No.: US 2014/0018512 A1
(43) Pub. Date: Jan. 16, 2014

(54) REACTANT COMPOSITION AND POLYESTER MADE THEREFROM

(71) Applicant: FAR EASTERN NEW CENTURY CORPORATION, Taipei City (TW)

(72) Inventors: Roy Wu, Taipei City (TW); Yi-Hsuan Tang, Taipei City (TW); Hsin-Yi Chou, Taipei City (TW)

(73) Assignee: FAR EASTERN NEW CENTURY CORPORATION, Taipei City (TW)

(21) Appl. No.: 13/905,928

(22) Filed: May 30, 2013

(30) Foreign Application Priority Data
Jul. 13, 2012 (TW) 101125314

(51) Int. Cl. C08G 63/672

(52) U.S. Cl. CPC C08G 63/672
USPC 528/307; 252/183.11

(57) ABSTRACT

A reactant composition includes: a diol component; a diacid-derived component; and a modifier represented by the following formula (I):

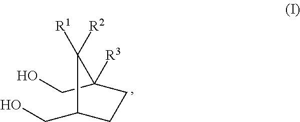

wherein R¹, R², and R³ independently represent H or a methyl group, and at least one of R¹, R², and R³ is a methyl group. A polyester made from the reactant composition is also disclosed.

### CROSS-REFERENCE TO RELATED APPLICATION

This application claims priority of Taiwanese Patent Application No. 101125314, filed on Jul. 13, 2012.

### BACKGROUND OF THE INVENTION

1. Field of the Invention

The present invention relates to a reactant composition and a polyester made from the reactant composition and having a relatively high glass transition temperature.

2. Description of the Related Art

Polyesters are formed by virtue of condensation polymerization of diol (or polyol) components and diacid (or polyacid) components, and common examples include polyethylene terephthalate (PET), polybutylene terephthalate (PBT), polytrimethylene terephthalate (PTT), poly-1,4-cyclohexane dimethylene terephthalate (PCT), and polyethylene naphthalate (PEN). Because PET has good elasticity, transparency and durability, and is environmental friendly, cost-effective, and easy to obtain, it is more widely used in producing filler materials, molding products and various thin films. However, PET suffers from insufficient heat resistance and easily deforms at an elevated temperature. Therefore, in general, a modifier is added to modify the structure of PET molecular chain so as to reduce the molecular chain mobility or change the crystallization morphology thereof, thereby improving the glass transition temperature and melting point properties.

In addition, to cope with “green” requirements and consider the crisis of petroleum exhaustion, several methods have been developed to prepare polyesters, especially PET, from biomass-derived diol components (e.g., ethylene glycol) and biomass-derived diacid components (e.g., terephthalic acid), such as those disclosed in US 2009/0246430, US 2010/0028512, and WO 2009064515. However, at present, the well known modifiers mainly originate from petroleum, examples of which include isophthalic acid (IPA), neopentyl glycol (NPG), and 1,4-cyclohexanedimethanol (CHDM).

Taiwanese Patent Publication No. 200804457 discloses a method for producing a polyester. The polyester is made of a mixture that includes a dicarboxylic acid component containing 70 to 100 mol % of terephthalic acid, and a diol component containing 1 to 99 mol % of 1,4-cyclohexanedimethanol as a modifier. However, in this patent publication, the copolymer of example 1B is made of a composition containing 80 mol % CHDM and has a glass transition temperature of 87.7° C., and the copolymer of example 1E is made from a composition containing 60 mol % CHDM and has a glass transition temperature of 82.1° C. It is evident from the abovementioned examples that a higher content of the 1,4-cyclohexanedimethanol) is required for preparing the polyester to achieve the effect of increasing the glass transition temperature.

It is desired in the art to provide a polyester composition including a small amount of a biomass-derived modifier that is capable of significantly enhancing thermal resistance.

### SUMMARY OF THE INVENTION

Therefore, the object of the present invention is to provide a polyester with good thermal resistance.

According to one aspect of the present invention, a reactant composition for producing a polyester includes:

a diol component;

a diacid-derived component; and

a modifier represented by the following formula (I)

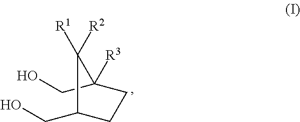

wherein R¹, R², and R³ independently represent H or a methyl group, and at least one of R¹, R², and R³ is a methyl group.

According to another aspect of the present invention, a polyester includes at least one first repeating unit and at least one second repeating unit that are respectively represented by the following formulas (A) and (B)

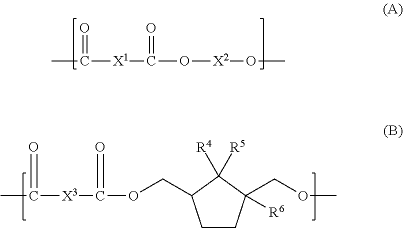

wherein the ratio of the first and second repeating units ranges from 70:30 to 99:1, X¹, X², and X³ independently representing an arylene group or an alkylene group, R⁴, R⁵, and R⁶ independently representing H or a methyl group, at least one of R⁴, R⁵, and R⁶ being a methyl group.

### BRIEF DESCRIPTION OF THE DRAWINGS

Other features and advantages of the present invention will become apparent in the following detailed description of the preferred embodiments with reference to the accompanying drawings, of which:

FIG. 1 is a ¹H-nuclear magnetic resonance spectrum of a polyester of Example 1 according to the present invention; and

FIG. 2 is a ¹H-nuclear magnetic resonance spectrum of a polyester of Comparative example 1.

### DETAILED DESCRIPTION OF THE PREFERRED EMBODIMENTS

A reactant composition for producing a polyester of the present invention comprises: a diol component, a diacid-derived component, and a modifier represented by the following formula (I):

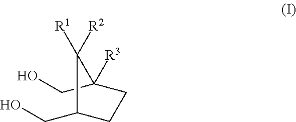

wherein R¹, R², and R³ independently represent H or a methyl group and at least one of R¹, R², and R³ is a methyl group.

Preferably, R¹, R², and R³ independently represent a methyl group, and the modifier is 1,2,2-trimethyl-1,3-bis(hydroxymethyl)cyclopentane.

Preferably, the modifier is prepared from camphor (1,7,7-trimethylbicyclo[2.2.1]heptan-2-one) that can be obtained from a petroleum source or a biomass source. By introducing the particular molecular structure of 1,7,7-trimethylbicyclo[2.2.1]heptan-2-one into the main chain of the polyester, the glass transition temperature can be increased. More preferably, the modifier is prepared from biomass-derived camphor.

The process for preparing the modifier from camphor includes, but is not limited to, adding camphor (as represented by following formula (I-0)) and FeSO₄.7H₂O at a molar ratio of 35:1 into a nitric acid aqueous solution followed by subjecting to oxidation reaction at 100 to 105° C. for 30 hours. The mixture is cooled to room temperature after the reaction is finished. A white precipitate (as represented by 1,2,2-trimethyl-1,3-dicarboxylic acid cyclopentane (as represented by formula (I-1)) is obtained. Next, lithium aluminum hydride (LAH) and 1,2,2-trimethyl-1,3-dicarboxylic acid cyclopentane are dissolved in tetrahydrofuran (THF) and are reacted at 80° C. for 5 hours to obtain 1,2,2-trimethyl-1,3-bis(hydroxymethyl)cyclopentane.

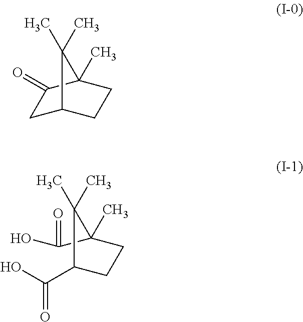

Preferably, the modifier is present in an amount ranging from 1 to 30 mol % based on total moles of the diol component and the modifier. When the amount of the modifier is less than 1 mol %, the effect of increasing glass transition temperature is not significant. When the amount of the modifier is greater than 30 mol %, the polymerization of the reactants becomes difficult, and the color of the resultant modified polyester is slightly yellowish. More preferably, the modifier is present in an amount ranging from 3 to 25 mol % based on the total moles of the diol component and the modifier.

Preferably, the diacid-derived component is selected from the group consisting of aromatic diacid, alkyl ester of aromatic diacid, aliphatic diacid, alkyl ester of aliphatic diacid, and combinations thereof.

Preferably, the aromatic diacid is a C₈-C₁₄ aromatic diacid. Examples of the C₈-C₁₄ aromatic diacid include terephthalic acid, phthalic acid, isophthalic acid, 2,6-naphthalic acid, and biphenyl carboxylic acid.

Preferably, the aliphatic diacid is a C₂-C₁₂ aliphatic diacid. Examples of the C₂-C₁₂ aliphatic diacid include linear aliphatic diacids, branch aliphatic diacids, and cycloaliphatic diacids. An example of the cycloaliphatic diacids is 1,4-cyclohexane dicarboxylic acid.

More preferably, the diacid-derived component is terephthalic acid or dimethyl terephthalate.

Preferably, the diol component is a C₂-C₁₂ aliphatic diol other than 1,2,2-trimethyl-1,3-bis(hydroxymethyl)cyclopentane. Examples of the diol component include ethylene glycol, triethylene glycol, propylene glycol, and butylene glycol.

Preferably, the ratio of the combined moles of the diol component and the modifier to the mole of the diacid-derived component ranges from 2:1 to 1:1. With such molar ratio, excess amount of the diol component and the modifier is provided while the amount of the diacid-derived component is limited so as to alleviate occurrence of a reverse reaction. Over excess of the diol component and the modifier results in unnecessary waste and higher material cost. Thus, preferably, the ratio of the combined moles of the diol component and the modifier to the mole of the di acid-derived component is 1.5:1. More preferably, the ratio of the combined moles of the diol component and the modifier to the mole of the diacid-derived component is 1.2:1.

This invention also provides a polyester made from the aforesaid reactant composition. The polyester includes at least one first repeating unit and at least one second repeating unit that are respectively represented by the following formulas (A) and (B):

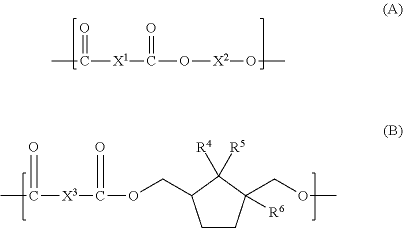

The molar ratio of the first and second repeating units ranges from 70:30 to 99:1. X¹, X², and X³ independently represent an arylene group or an alkylene group. R⁴, R⁵, and R⁶ independently represent H or a methyl group and at least one of and R⁵ is a methyl group. Preferably, at least one of X¹, X², and X³ is an arylene group. Preferably, R⁴, R⁵, and R⁶ independently represent a methyl group. More preferably, R⁴, R⁵, and R⁶ independently represent a methyl group, X¹ and X³ independently represent

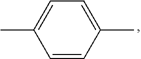

and X² represents —CH2CH₂—.

The main chain of the polyester has a cyclopentane structure provided by the modifier (see the second repeating unit of formula (B)). When R⁶ is a methyl group, the main chain is difficult to move, thereby achieving the effect of increasing the glass transition temperature. In addition to R⁶, if at least one of R⁴ and R⁵ is a methyl group, the cyclopentane structure in the polyester is more difficult to rotate, thereby further increasing the glass transition temperature.

It is noted that, in the conventional method, a byproduct diethylene glycol (DEG) is generated by ethylene glycol. DEG is a toxic substance that may be harmful to the lungs and kidneys, even causing death, and may result in lowering of the glass transition temperature and poor thermal resistance. Because of addition of the modifier, the amount of the ethylene glycol used in the reaction mixture is correspondingly reduced, so that the amount of the DEG generated thereby is correspondingly reduced. In addition, the existence of the modifier may interfere with the original molecular arrangement of polyester. Therefore, the effect of lowering the crystallization temperature can be achieved, so that the polyester is difficult to be whitened due to crystallization in the process. Therefore, the polyester can be used to prepare a transparent product, for example, bottles, plastic sheets, etc.

It is noted that the polyester of this invention has a glass transition temperature greater than that of the unmodified polyester by 1 to 15° C.

Preferably, preparation of the polyester of this invention is conducted by subjecting the reactant composition of this invention to a direct esterification reaction or an ester interchange reaction at 160 to 250° C. until the conversion rate reaches more than 95% so as to obtain an oligomer. Next, a catalyst is added into the oligomer to conduct a condensation polymerization so as to form the modified polyester. The catalyst includes, but is not limited to, antimony containing compound (such as antimony (III) oxide, b₂O₃), germanium containing compound, tin containing compound, titanium containing compound, gallium containing compound, and aluminum containing compound. The condensation polymerization is conducted under 1 torr and from 200° C. to 300° C. When the temperature is greater than 300° C., chain scission degradation is significant, and thus a polyester with a high molecular weight is difficult to be obtained. More preferably, the condensation polymerization is conducted at 250 to 280° C.

Examples of the present invention will be described hereinafter. It is to be understood that these examples are exemplary and explanatory and should not be construed as a limitation to the present invention.

### EXAMPLES

### <Chemicals and Instruments>

1. Camphor: available from Aldrich Co., purity: 96%.

2. FeSO₄.7H₂O: available from Aldrich Co., reagent grade.

3. Lithium aluminum hydride: available from Aldrich Co., reagent grade, purity: 95%, powder form.

4. Tetrahydrofuran: available from Aldrich Co., industrial grade, purity≧99.0%.

5. Ethylene glycol: available from Oriental Union Chemical Co.

6. Dimethyl terephthalate: available from Aldrich Co., purity≧99.0%.

7. Sb₂O₃: available from Aldrich Co., purity: 99.999%.

8. Differential scanning calorimeter (DSC): manufactured by TA instrument Co., USA, model No.: DSC 2910.

9. Nuclear magnetic resonance (NMR): manufactured by Bruker Co., model No.: Avance NMR.

10. Gas chromatograph (GC): manufactured by Perkin elmer Co., model No.: Autosystem X1.

### PREPARATION EXAMPLE

### Preparation of 1,2,2-trimethyl-1,3-bis(hydroxymethyl)cyclopentane

Camphor and FeSO₄.7H₂O were added into a nitric acid aqueous solution at a molar ratio of 35:1 and were subjected to an oxidation reaction at reflux temperature of 100 to 105° C. for 30 hours to obtain a mixture. The mixture was cooled to room temperature so as to obtain a white precipitate, i.e., 1,2,2-trimethyl-1,3-dicarboxylic acid cyclopentane. Next, 1,2,2-trimethyl-1,3-dicarboxylic acid cyclopentane was dissolved in tetrahydrofuran and was added with lithium aluminum hydride as a catalyst (the molar ratio of 1,2,2-trimethyl-1,3-dicarboxylic acid cyclopentane to lithium aluminum hydride was 1:4), followed by reacting at 80° C. for 5 hours and filtering to remove the solvent, i.e., tetrahydrofuran, so as to obtain 1,2,2-trimethyl-1,3-bis(hydroxymethyl)cyclopentane.

### EXAMPLES

### Preparation of Modified Polyester

### Example 1

### E1

1,2,2-trimethyl-1,3-bis(hydroxymethyl)cyclopentane obtained in the preparation example was mixed uniformly with ethylene glycol at a molar ratio 3:97 to form a mixture, followed by mixing uniformly the mixture with dimethyl terephthalate at a molar ratio of 1.25:1 to form a reaction mixture.

A catalyst, manganese acetate (1000 ppm), was added in the reaction mixture and an ester interchange reaction was conducted at 160 to 250° C. until the conversion rate reached 95% to obtain an oligomer with low polymerization degree. Next, Sb₂O₃ (300 ppm) was added in the oligomer to conduct a condensation polymerization reaction at 1 torr and from 250 to 280° C. for 3 hours. A modified polyester of Example 1 was obtained.

### Examples 2 and 3

### E2 and E3

In Examples 2 and 3, the same steps as those in Example 1 were performed to prepare respectively the modified polyester of Examples 2 and 3, except that the molar ratios of 1,2,2-trimethyl-1,3-bis(hydroxymethyl)cyclopentane and ethylene glycol were 10:90 and 25:75 in Examples 2 and 3, respectively (see Table 1).

### Comparative Example 1

### CE1

The steps for preparing the polyester in Comparative example 1 were similar to those in Example 1, except that 1,2,2-trimethyl-1,3-bis(hydroxymethyl)cyclopentane was not used in Comparative example 1.

### <Analysis Test>

### 1. Measurement of Glass Transition Temperature, Melting Point and Crystallization Temperature

The modified polyesters of Examples 1 to 3 and the polyester of Comparative example 1 were respectively formed into polyester pellets. The glass transition temperature, melting point and crystallization temperature (Tcc) of the polyester pellets were measured using differential scanning calorimeter (DSC).

With reference to the operation manual of the DSC, the measurement process was as follows: conducting a first temperature increasing step at an increasing rate of 10° C. per minute to reach a temperature of 300° C.; conducting a first temperature decreasing step at a decreasing rate of 10° C. per minute to reach a temperature of 30° C.; conducting a second temperature increasing step at an increasing rate of 10° C. per minute; measuring the glass transition temperature and the melting point; heating until the temperature was greater than the melting point; and measuring the crystallization temperature after cooling. The measurement results of Example 1 to 3 and Comparative example 1 are shown in Table 1.

### 2. Structure Determination

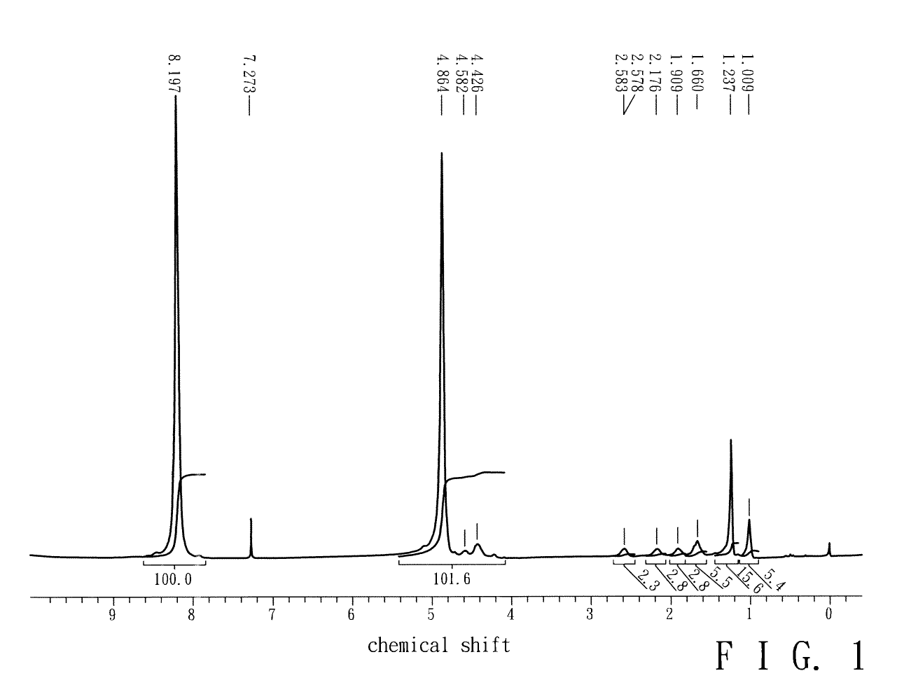

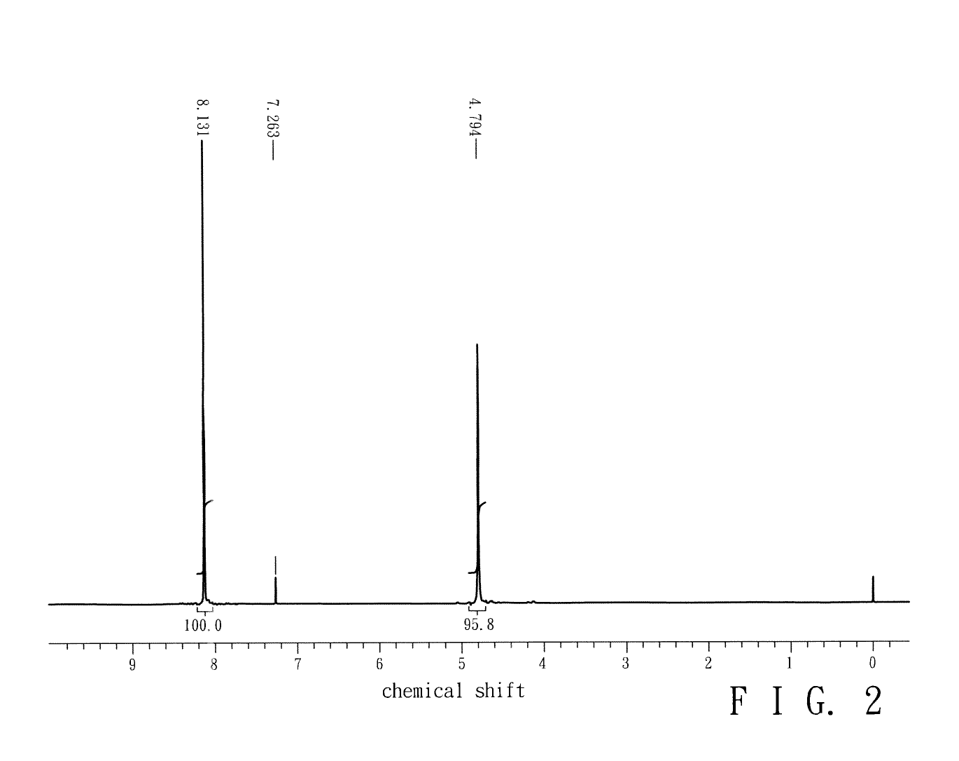

The structures of the modified polyester of Example 1 and the polyester of Comparative example 1 were determined by ¹H NMR. The polyester pellets obtained by Example 1 and Comparative example 1 were dissolved in trifluoro acetic acid (30%) and were diluted using deuterochloroform (CDCl₃), followed by detecting hydrogen spectra using nuclear magnetic resonance at 300 MHz. The spectra are shown in FIG. 1 and FIG. 2.

3. Measurement of the Amount of Diethylene Glycol (DEG)

The contents of the diethylene glycol in Examples 1, 2, and 3 and Comparative example 1 were measured using gas chromatography. First, the polyester pellets obtained by Examples 1 to 3 and Comparative example 1 were added in 1,4-butylene glycol and were dissolved by means of potassium hydroxide/n-propanol, followed by adding hydrogen chloride (1.6N) and stirring uniformly. Thereafter, the supernatant liquid was obtained and injected into a gas chromatograph to measure the concentration of DEG. The results are shown in Table 1.

TABLE 1

| | Content | | Glass | | |
|---|---|---|---|---|---|
| | of | Content | transition | Crystallization | Melting |
| | modifier | of DEG | Temperature | temperature | point |
| No. | (mol %)*¹ | (wt %) | (Tg) (° C.) | (Tcc) (° C.) | (Tm) (° C.) |
| E1 | 3 | 0.72 | 82.0 | 184.21 | 232.6 |
| E2 | 10 | 0.42 | 84.0 | 161.76 | 231.8 |
| E3 | 25 | 0.20 | 87.1 | N.A.*² | N.A.*² |
| CE1 | 0 | 3.97 | 77.3 | 192.10 | 247.4 |

*¹based on total moles of the diol component and the modifier (1,2,2-trimethy1-1,3-bis(hydroxymethyl) cyclopentane)
*²┌N.A.┘ indicates no melting point or crystallization temperature of the polymer was detected, i.e., the polymer was an amorphous polymer

FIG. 2 illustrates the ¹H-nuclear magnetic resonance spectrum of the unmodified polyester of Comparative example 1. The spectrum in FIG. 2 includes a signal at 8.13 ppm, that is provided by the hydrogen on the benzene ring, and a signal at 4.79 ppm that represents the —CH₂— group on the main chain from the ethylene glycol. FIG. 1 illustrates the ¹H-nuclear magnetic resonance spectrum of the modified polyester of Example 1. The spectrum in FIG. 1 includes a signal at 8.197 ppm that is provided by the hydrogen on the benzene ring, signals at 4.864 ppm and 4.426 ppm that represent the —CH₂— groups on the main chain respectively from the ethylene glycol and the modifier, (1,2,2-trimethyl-1,3-bis(hydroxymethyl)cyclopentane), and peaks at 2.583 to 1.009 ppm that are respectively provided by the hydrogen groups in the modifier (1,2,2-trimethyl-1,3-bis(hydroxymethyl)cyclopentane). It is evident from FIG. 1 and FIG. 2 that the polyester of Example 1 contains functional groups from the modifier.

It is evident from Table 1 that, in Comparative example 1 where no modifier is added, the produced polyethylene terephthalate has a glass transition temperature of 77.3° C., and the DEG is present in an amount of 3.97 wt %. On the other hand, in Example 1, the amount of 1,2,2-trimethyl-1,3-bis(hydroxymethyl)cyclopentane is 3 mol % based on the total moles of the diol component and the modifier, the glass transition temperature of the modified polyethylene terephthalate is increased to 82.0° C., the content of DEG is reduced to 0.72 wt %, and the crystallization temperature and melting point are obviously lower than those of the polyester of Comparative example 1.

In Examples 2 and 3, the amounts of 1,2,2-trimethyl-1,3-bis(hydroxymethyl)cyclopentane are respectively 10 mol % and 25 mol % based on the total moles of the diol component and the modifier, the glass transition temperatures of the modified polyethylene terephthalates are respectively increased to 84.0° C. and 87.1° C., the contents of DEG are respectively reduced to 0.42 wt % and 0.20 wt %, and the crystallization temperatures and melting points are more obviously decreased.

To sum up, with the inclusion of the modifier from camphor, the polyester of this invention exhibits increased glass transition temperature, reduced melting point and crystallization temperature, and reduced amount of diethylene glycol. Moreover, the modifier can be prepared from a biobased material and the amount thereof is lower than that used in the conventional composition.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A reactant composition for producing a polyester, comprising:
a diol component;
a diacid-derived component; and
a modifier represented by the following formula (I): 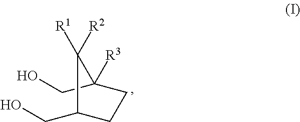
wherein R¹, R², and R³ independently represent H or a methyl group, and at least one of R¹, R², and R³ is a methyl group.

2. The reactant composition as claimed in claim 1, wherein said modifier is 1,2,2-trimethyl-1,3-bis(hydroxymethyl)cyclopentane.

3. The reactant composition as claimed in claim 1, wherein said modifier is prepared from 1,7,7-trimethylbicyclo[2.2.1]heptan-2-one.

4. The reactant composition as claimed in claim 1, wherein said modifier is present in an amount ranging from 1 to 30 mol % based on total moles of said diol component and said modifier.

5. The reactant composition as claimed in claim 1, wherein said modifier is present in an amount ranging from 3 to 25 mol % based on the total moles of said diol component and said modifier.

6. The reactant composition as claimed in claim 1, wherein said diacid-derived component is selected from the group consisting of aromatic diacid, alkyl ester of aromatic diacid, aliphatic diacid, alkyl ester of aliphatic diacid, and combinations thereof.

7. The reactant composition as claimed in claim 1, wherein said diacid-derived component is terephthalic acid or dimethyl terephthalate.

8. The reactant composition as claimed in claim 1, said diol component is a C₂-C₁₂ aliphatic diol.

9. A polyester comprising at least one first repeating unit and at least one second repeating unit that are respectively represented by the following formulas (A) and (B): 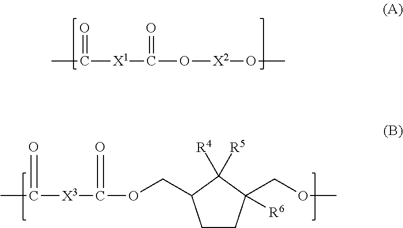
wherein the ratio of said first and second repeating units ranges from 70:30 to 99:1, X¹, X², and X³ independently representing an arylene group or an alkylene group, R⁴, R⁵, and R⁶ independently representing H or a methyl group, at least one of R⁴, R⁵, and R⁶ being a methyl group.

10. The polyester as claimed in claim 9, wherein at least one of X¹, X², and X³ is an arylene group.

11. The polyester as claimed in claim 9, wherein R⁴, R⁵, and R⁶ independently represent a methyl group.
